(19) United States
(12) Patent Application Publication
(10) Pub. No.: US 2026/0200291 A1
(43) Pub. Date: Jul. 16, 2026

(54) ELECTRIC COMPRESSOR

(71) Applicant: SANDEN CORPORATION, Isesaki-shi, Gunma (JP)

(72) Inventors: Mikio KOBAYASHI, Isesaki-shi, Gunma (JP); Kazuya IIZUKA, Isesaki-shi, Gunma (JP)

(73) Assignee: SANDEN CORPORATION, Isesaki-shi, Gunma (JP)

(21) Appl. No.: 19/134,838

(22) PCT Filed: Dec. 25, 2023
(86) PCT No.: PCT/JP2023/046385

§ 371 Date: Jun. 2, 2025

(30) Foreign Application Priority Data
Jan. 13, 2023 (JP) 2023-003543

(51) Int. Cl. B60H 1/32; B60H 1/00

(52) U.S. Cl. CPC B60H 1/3226; B60H 1/00507; B60H 2001/006; B60H 2001/3292

(57) ABSTRACT

In an electric compressor, a target electronic component group of a noise reduction element and a voltage smoothing element in a posture of being attached to a circuit board of an inverter is covered with a block body formed in a block shape and made of thermoplastic resin. The circuit board has one surface which faces a bottom wall located on a housing side in an inverter accommodation portion and to which the target electronic component group is attached, the inverter accommodation portion has a plurality of recessed portions formed in a portion of the bottom wall facing an end surface of the block body, and the block body has a plurality of protruding portions protruding from the end surface thereof toward the bottom wall, each of the plurality of protruding portions being fitted in a corresponding one of the plurality of recessed portions facing such a protruding portion.

### CROSS-REFERENCE TO RELATED APPLICATIONS

This application is a U.S. National Stage Patent Application under 37 U.S.C. § 371 of International Patent Application No. PCT/JP 2023/046385, filed on Dec. 25, 2023, which claims the benefit of Japanese Patent Application No. JP 2023-003543, filed on Jan. 13, 2023, the disclosures of each of which are incorporated herein by reference in their entirety.

### TECHNICAL FIELD

The present invention relates to an electric compressor integrally having an inverter.

### BACKGROUND ART

Many electric compressors used for compressing refrigerant in vehicle air conditioners and the like integrally have inverters, and control power supply to electric motors that drive compression mechanisms while converting DC power from in-vehicle batteries or the like into AC power (drive the electric motors). In the circuit of the inverter, a noise reduction element (also referred to as a noise filter) for reducing noise and a voltage smoothing element (also referred to as a smoothing capacitor) for smoothing the voltage of the DC power input to the inverter are incorporated. One example of these electric compressors is described in Patent Literature 1. In the electric compressor described in Patent Literature 1, the entirety of the noise filter and the smoothing capacitor is covered with resin from the viewpoint of vibration resistance.

Here, the inverter includes the noise reduction element and the voltage smoothing element (noise filter and smoothing capacitor), and for the noise reduction element and the voltage smoothing element, reduction in a temperature increase due to heat generation has been demanded. In this regard, Patent Literature 1 discloses that a heat dissipation sheet member is interposed between an outer wall of an assembly including a noise filter, a smoothing capacitor, and resin covering the noise filter and the smoothing capacitor and an inner wall of a housing, so that heat generated from an electronic component in the assembly is dissipated through the heat dissipation sheet member.

### CITATION LIST

### Patent Literature

Patent Literature 1: JP-A-2013-36394

### SUMMARY OF INVENTION

### Problems to be Solved by Invention

However, in the above-described configuration, it is necessary to dispose the heat dissipation sheet member between the assembly and the housing, and there is still room for improvement from the viewpoint of a cost and the like.

Thus, an object of the present invention is to provide an electric compressor with a reduced number of components as compared with the related art and the heat dissipation (cooling performance) of a noise reduction element and a voltage smoothing element.

### Solution to Problems

According to one aspect of the present invention, an electric compressor is provided. The electric compressor includes an electric motor, a compression mechanism driven by the electric motor to compress refrigerant, an inverter including a target electronic component group of a noise reduction element and a voltage smoothing element and driving the electric motor, a housing accommodating the compression mechanism and the electric motor, an inverter accommodation portion provided adjacent to the housing and accommodating the inverter, and a block body covering the target electronic component group in a posture of being attached to a circuit board of the inverter, formed in a block shape, and made of resin. In this electric compressor, the circuit board has one surface which faces a bottom wall located on a housing side in the inverter accommodation portion and to which the target electronic component group is attached, the resin is thermoplastic resin, the inverter accommodation portion has a plurality of recessed portions formed in a portion of the bottom wall facing an end surface of the block body, and the block body has a plurality of protruding portions protruding from the end surface toward the bottom wall, each of the protruding portions being fitted in a corresponding one of the plurality of recessed portions facing such a protruding portion.

### Effects of Invention

According to the present invention, the electric compressor can be provided with the reduced number of components as compared with the related art and the heat dissipation (cooling performance) of the noise reduction element and the voltage smoothing element.

### BRIEF DESCRIPTION OF DRAWINGS

FIG. 1 is a schematic longitudinal sectional view of an electric compressor according to an embodiment.

FIG. 2 is a view of the electric compressor according to the embodiment in a state of a cover member of an inverter accommodation portion being detached as viewed from the inverter accommodation portion side.

FIG. 3 is a diagram illustrating one example of a circuit of an inverter of the electric compressor according to the embodiment.

FIG. 4 is a view for describing a state before a target electronic component group in a posture of being attached to a circuit board is covered with a block body.

FIG. 5 is a view for describing a state of the target electronic component group being covered with the block body.

FIG. 6 is an exploded perspective view for describing an internal structure of the inverter accommodation portion.

FIG. 7 is a perspective view for describing a plurality of protruding portions on an end surface of the block body.

FIG. 8 is a partially enlarged perspective view of FIG. 7.

FIG. 9 is an enlarged plan view of the end surface of a block body.

FIG. 10 shows views for describing deformation of the protruding portion when the protruding portion is fitted in the recessed portion, FIG. 10(a) being a partial sectional view before the deformation and FIG. 10(b) being a partial sectional view after the deformation.

### DESCRIPTION OF EMBODIMENTS

An embodiment of the present invention will be described hereinafter with reference to the accompanying drawings.

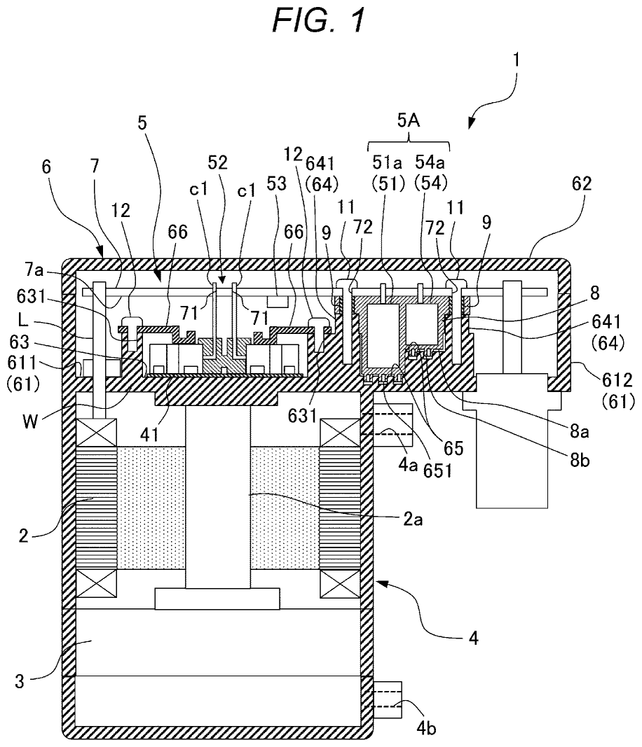

FIG. 1 is a schematic longitudinal sectional view of an electric compressor 1 according to one embodiment of the present invention. The electric compressor 1 according to the embodiment is a so-called inverter-integrated electric compressor integrally having an inverter. For example, the electric compressor 1 may be mounted on a vehicle to form part of a refrigerant circuit of a vehicle air conditioner, and may be configured to compress and discharge refrigerant.

Referring to FIG. 1, the electric compressor 1 includes an electric motor 2, a compression mechanism 3 driven by the electric motor 2 to compress refrigerant, a housing 4 that accommodates the electric motor 2 and the compression mechanism 3, an inverter 5 that drives the electric motor 2, and an inverter accommodation portion 6 provided adjacent to the housing 4 and accommodating the inverter 5.

The electric motor 2 is, for example, a three-phase synchronous motor (brushless DC motor). The compression mechanism 3 is, for example, a scroll compression mechanism. The electric motor 2 and the compression mechanism 3 are disposed in series in the axial direction of an output shaft 2a of the electric motor 2 in the housing 4. The output shaft 2a of the electric motor 2 is coupled to the compression mechanism 3 (orbiting scroll in the case of the scroll compression mechanism).

The inverter 5 includes various electronic components (described later) and a circuit board 7 to which these various electronic components are attached (mounted). In other words, in the present embodiment, various electronic components are attached to the circuit board 7 to form the inverter 5.

The inverter accommodation portion 6 is provided adjacent to the housing 4. The inverter accommodation portion 6 is disposed on one end side of the housing 4 in the axial direction, specifically on the opposite side of the electric motor 2 from the compression mechanism 3, and is provided integrally with the housing 4. In the present embodiment, the inverter accommodation portion 6 includes an accommodation portion body 61 formed integrally with the housing 4 and a cover member 62 detachable from the accommodation portion body 61.

The accommodation portion body 61 has a bottom wall 611 located on the housing 4 side in the inverter accommodation portion 6, and a peripheral wall 612 standing from the peripheral edge of the bottom wall 611 and defining an opening facing the bottom wall 611. The cover member 62 is attached to the accommodation portion body 61 to close the opening. Part of the bottom wall 611 (which is also the bottom wall of the inverter accommodation portion 6) of the accommodation portion body 61 forms a partitioning wall W that separates the inside of the housing 4 and the inside of the inverter accommodation portion 6 from each other. Note that a power supply line L from the inverter 5 to the electric motor 2 extends so as to penetrate the partitioning wall W in an airtight and liquid-tight state.

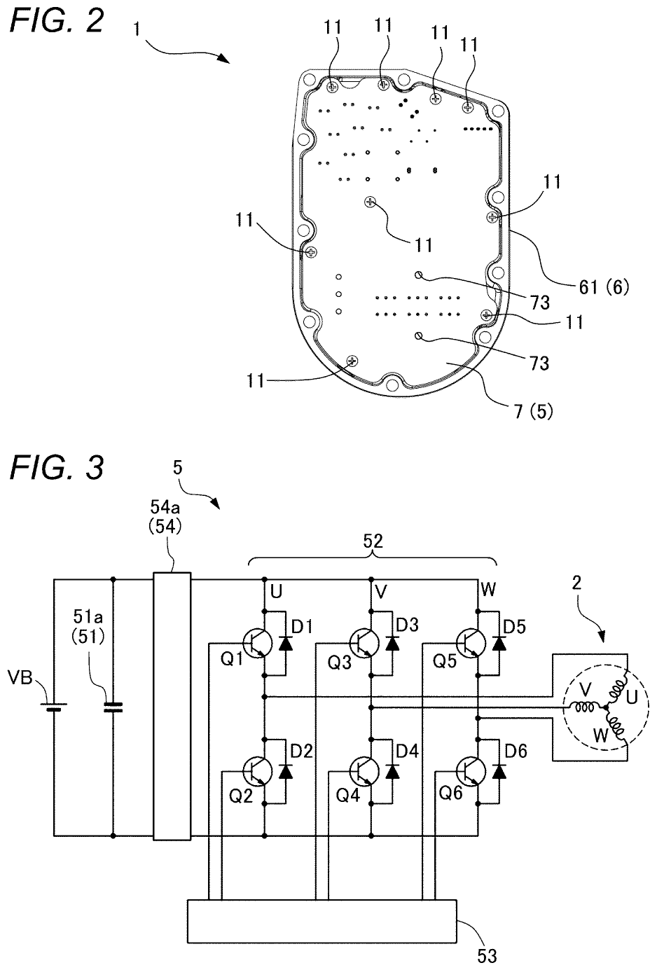

FIG. 2 is a view of the electric compressor 1 in a state of the cover member 62 of the inverter accommodation portion 6 being detached as viewed from the inverter accommodation portion 6 side. As illustrated in FIG. 2, the circuit board 7 forming the inverter 5 is attached in the inverter accommodation portion 6 (accommodation portion body 61) with a plurality of board fixing bolts 11 (fixing members).

Returning to FIG. 1, a refrigerant inlet 4a is formed in a portion of the housing 4 on the partitioning wall W side. Refrigerant having flowed into the housing 4 flows in the housing 4 (gap in the electric motor 2) and reaches the compression mechanism 3, and the compression mechanism 3 is driven by the electric motor 2 to compress and discharge the refrigerant. The refrigerant having flowed into the housing 4 is, for example, refrigerant having passed through an expansion valve, an evaporator, and the like in the refrigerant circuit of the vehicle air conditioner, and is low-temperature low-pressure refrigerant. Thus, the bottom wall 611 including the partitioning wall W and the electric motor 2 can be cooled with the refrigerant having flowed into the housing 4 through the refrigerant inlet 4a. The refrigerant having flowed in the housing 4 is compressed into high-temperature high-pressure refrigerant by the compression mechanism 3, and is discharged from the compression mechanism 3. Then, the (high-temperature high-pressure) refrigerant discharged from the compression mechanism 3 flows out through a refrigerant outlet 4b formed in the housing 4.

Here, the inverter 5 will be briefly described. FIG. 3 is a diagram illustrating one example of a circuit configuration of the inverter 5. In the present embodiment, the inverter 5 is configured to convert DC power from an external power source (for example, in-vehicle battery) VB into three-phase AC power and supply the three-phase AC power to the electric motor 2.

As illustrated in FIG. 3, the inverter 5 includes a voltage smoothing unit 51, a switching unit 52, a control unit (control circuit) 53, and a noise filter 54. As described above, these components are mounted on the circuit board 7 to form the inverter 5.

The voltage smoothing unit 51 includes a smoothing capacitor which is a voltage smoothing element 51a. The voltage smoothing unit 51 is connected between a power line and a ground line of the external power source VB, and smooths DC voltage from the external power source VB.

The switching unit 52 has six power switching elements Q1 to Q6 and six diodes D1 to D6. Although not particularly limited, the power switching elements Q1 to Q6 may be insulated gate bipolar transistors (IGBTs). The switching unit 52 is configured to convert the DC voltage smoothed by the voltage smoothing element 51a after having been supplied from the external power source VB into three-phase AC voltage and supply the three-phase AC voltage to the electric motor 2 by control (PMW control) of the power switching elements Q1 to Q6.

The switching unit 52 will be further described. The switching unit 52 has a U-phase arm, a V-phase arm, and a W-phase arm provided in parallel with each other between the power line and the ground line of the external power source VB. Two power switching elements Q1, Q2 are connected in series to the U-phase arm, and the diodes D1, D2 are each connected in inverse parallel to the power switching elements Q1, Q2. Two power switching elements Q3, Q4 are connected in series to the V-phase arm, and the diodes D3, D4 are each connected in inverse parallel to the power switching elements Q3, Q4. Two power switching elements Q5, Q6 are connected in series to the W-phase arm, and the diodes D5, D6 are each connected in inverse parallel to the power switching elements Q5, Q6.

The midpoint of each of the U-, V-, and W-phase arms is connected to the other end of each of U-, V-, and W-phase coils of the electric motor 2 star-connected at one ends thereof. That is, the midpoint between the power switching elements Q1, Q2 for the U-phase arm is connected to the U-phase coil, the midpoint between the power switching elements Q3, Q4 for the V-phase arm is connected to the V-phase coil, and the midpoint between the power switching elements Q5, Q6 for the W-phase arm is connected to the W-phase coil.

By controlling a ratio between the ON period of the power line-side power switching element and the ON period of the ground line-side power switching element for each phase arm, i.e., by performing the PWM control on the plurality of power switching elements Q1 to Q6, the switching unit 52 can convert the DC power smoothed by the voltage smoothing element 51a after having been supplied from the external power source VB into the three-phase AC power and supply the three-phase AC power to the electric motor 2, thereby driving the electric motor 2.

The control unit 53 controls (PWM control) the power switching elements Q1 to Q6 to drive the electric motor 2 and thus the compression mechanism 3 based on an external signal (for example, control signal from a control device for the vehicle air conditioner described above).

The noise filter 54 includes a noise reduction element 54a such as a capacitor or a coil (inductor) (not illustrated). Although not particularly limited, in the present embodiment, the noise filter 54 is provided between the voltage smoothing unit 51 and the switching unit 52, and mainly reduces ripple noise, EMI/EMC noise, or the like due to operation of the power switching elements Q1 to Q6.

The noise reduction element 54a and the voltage smoothing element 51a (hereinafter referred to as a target electronic component group 5A as appropriate) are relatively large and heavy components among the plurality of electronic components forming the circuit of the inverter 5, and are susceptible to vibration. As described above, the inverter 5 is configured, which includes the target electronic component group 5A of the noise reduction element 54a and the voltage smoothing element 51a and driving the electric motor 2.

Returning to FIG. 1, the circuit board 7 has one surface 7a facing the bottom wall 611 located on the housing 4 side in the inverter accommodation portion 6 (accommodation portion body 61). The target electronic component group 5A is attached to the one surface 7a of both surfaces of the circuit board 7 facing the bottom wall 611. That is, the circuit board 7 has the one surface 7a (in other words, the surface of the circuit board 7 on the partitioning wall side) which faces the bottom wall 611 of the inverter accommodation portion 6 and to which the target electronic component group 5A is attached.

Although not particularly limited, in the present embodiment, among the electronic components forming the inverter 5, the electronic components forming the power switching elements Q1 to Q6 of the switching unit 52 and the control unit 53 are attached to the one surface 7a of the circuit board 7 similarly to the target electronic component group 5A. That is, in the present embodiment, the electronic components forming the switching unit 52 and the control unit 53 are attached to the circuit board 7 together with the target electronic component group 5A.

Referring to FIG. 1, the electric compressor 1 includes a block body 8 covering the target electronic component group 5A of the noise reduction element 54a and the voltage smoothing element 51a. As illustrated in FIG. 1, the block body 8 is a member covering the target electronic component group 5A in a posture of being attached to the circuit board 7 of the inverter 5, formed in a block shape, and made of resin. That is, in a state of the target electronic component group 5A being electrically connected and attached to the circuit board 7, the block body 8 is molded from resin so as to cover the periphery of the target electronic component group 5A, and is integrated with the circuit board 7.

The resin used for the block body 8 is thermoplastic resin, and is, for example, thermoplastic elastomer having elasticity close to that of rubber and having favorable moldability comparable to that of plastic, such as thermoplastic polyurethane elastomer, thermoplastic polyester-based elastomer, or thermoplastic poly amide-based elastomer. In the case of these resins, the injection pressure of the resin during molding is lower than the injection pressure in the case of general injection molding and higher than the atmospheric pressure. Thus, a load on the electronic component during molding is reduced as compared with the case of injection molding. Note that the shape of the block body 8 will be described in detail later.

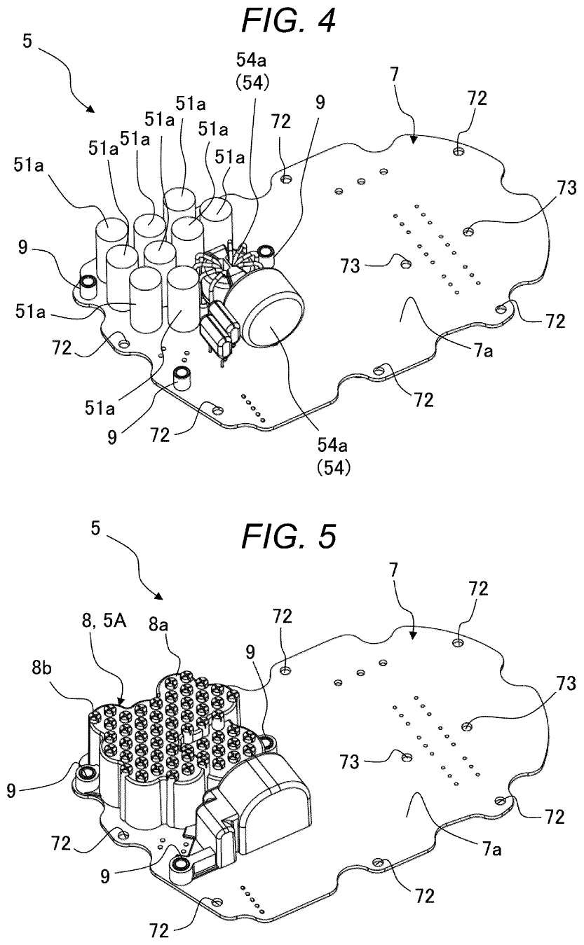

FIG. 4 is a view for describing a state before the target electronic component group 5A in the posture of being attached to the circuit board 7 is covered with the block body 8, and FIG. 5 is a view for describing a state of the target electronic component group 5A being covered with the block body 8. As illustrated in FIG. 4, the target electronic component group 5A (noise reduction element 54a and voltage smoothing element 51a) is attached so as to be concentrated on a predetermined region on the one surface 7a of the circuit board 7. The block body 8 is integrated with the circuit board 7 as illustrated in FIG. 5 by covering the target electronic component group 5A in the posture of being attached to the one surface 7a of the circuit board 7.

Next, a structure for accommodating the inverter 5 in the present embodiment will be described. As described above, in the present embodiment, the inverter 5 is accommodated in the inverter accommodation portion 6.

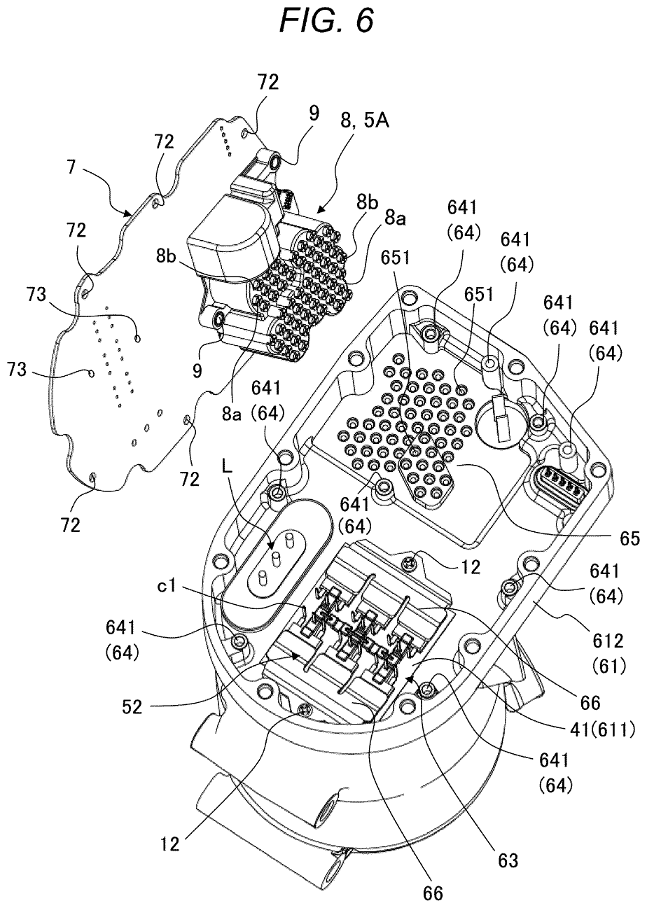

FIG. 6 is an exploded perspective view for describing an internal structure of the inverter accommodation portion 6. As described above, the inverter accommodation portion 6 includes the accommodation portion body 61 and the cover member 62.

Moreover, in the present embodiment, the inverter accommodation portion 6 includes therein a first installation portion 63 on which the power switching elements Q1 to Q6 are installed, a board support portion 64 supporting the circuit board 7, and a second installation portion 65 on which the block body 8 is installed. Note that since FIG. 1 is the schematic sectional view, the shape of the inner bottom surface of the accommodation portion body 61 illustrated in FIG. 1 does not precisely match the shape of the inner bottom surface of the accommodation portion body 61 illustrated in FIG. 6.

The first installation portion 63 is set on the inner bottom surface of the accommodation portion body 61, specifically on the inverter accommodation portion 6-side surface of the partitioning wall W which is part of the bottom wall 611, and is formed as a flat surface. In the present embodiment, the power switching elements Q1 to Q6 are disposed in two lines. That is, the power switching elements Q1, Q3, Q5 are disposed on one side, and the power switching elements Q2, Q4, Q6 are disposed on the other side. A bolt hole 631 into which an element fixing bolt 12 as a fixing member for fixing the power switching elements Q1 to Q6 is screwed is formed in the vicinity of the first installation portion 63.

The board support portion 64 is configured to support the circuit board 7 at a position farther from the partitioning wall W (the surface thereof on the inverter accommodation portion 6 side) than the first installation portion 63. That is, in the inverter accommodation portion 6, the circuit board 7 is disposed at a position closer to the cover member 62 than the power switching elements Q1 to Q6. In the present embodiment, the board support portion 64 includes a plurality of leg portions 641 protruding from the inner bottom surface of the accommodation portion body 61, i.e., the inverter accommodation portion 6-side surface of the partitioning wall W, and bolt holes into which the above-described board fixing bolts 11 (see FIG. 2) are screwed are each formed in the upper surfaces of the plurality of leg portions 641.

The second installation portion 65 is set on the inner bottom surface of the accommodation portion body 61, specifically on the surface of a portion of the bottom wall 611 facing an end surface 8a of the block body 8. Most of the surface of the second installation portion 65 is formed as a flat surface, and part of the second installation portion 65 is formed so as to protrude to the cover member 62 side. A plurality of recessed portions 651 is formed in the second installation portion 65. That is, the inverter accommodation portion 6 has the plurality of recessed portions 651 formed in a portion of the bottom wall 611 facing the end surface 8a of the block body 8.

The plurality of recessed portions 651 is arranged at intervals, and is formed as bottomed holes having the same shape. In the present embodiment, each of the plurality of recessed portions 651 is formed as a straight circular hole.

Referring to FIG. 6, each of the power switching elements Q1 to Q6 has three terminals c1. In the present embodiment, the three terminals cl extend laterally from one side surface of the power switching element, are bent in the middle, and face upward at the tip ends thereof. In the present embodiment, the power switching elements Q1 to Q6 are fixed to the first installation portion 63 through two element fixing bolts 12 and a plate 66 in a state of being placed on the first installation portion 63 of the inverter accommodation portion 6 through an insulating sheet 41.

Specifically, the insulating sheet 41 is made of a material having heat dissipation and insulating properties, and has a size capable of covering the entire lower surfaces of the power switching elements Q1 to Q6. The insulating sheet 41 is sandwiched between the lower surfaces of the power switching elements Q1 to Q6 and the first installation portion 63. The power switching elements Q1 to Q6 are fixed by being sandwiched between the plate 66 and the insulating sheet 41 for each line. The portion where the bolt holes 631 for the element fixing bolts 12 are formed protrudes to the cover member 62 side, and the base end of the plate 66 is fixed to the portion where the bolt holes 631 are formed with the element fixing bolts 12. As a result, the power switching elements Q1, Q3, Q5 and the power switching elements Q2, Q4, Q6 are pressed and fixed to the first installation portion 63 with the element fixing bolts 12 and the plate 66.

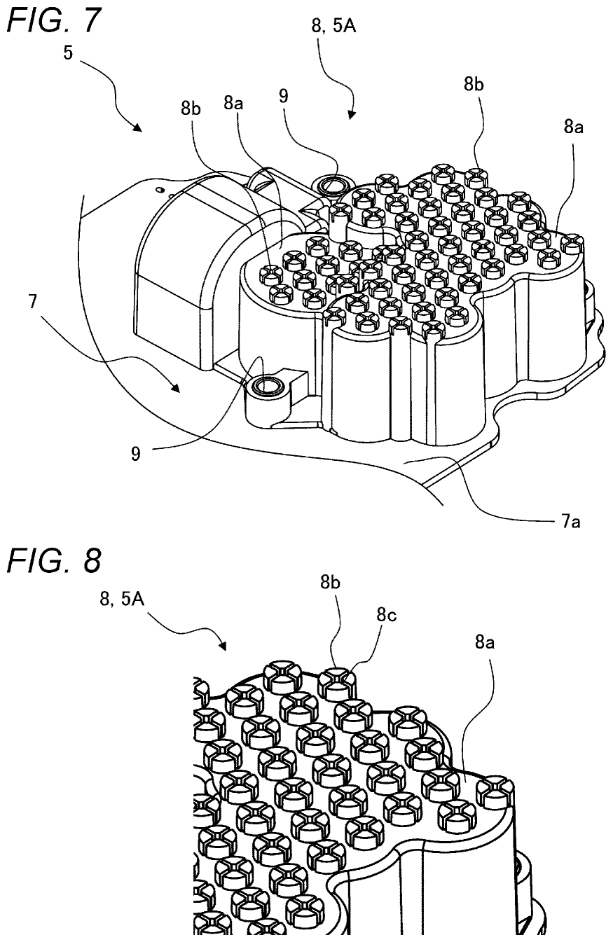

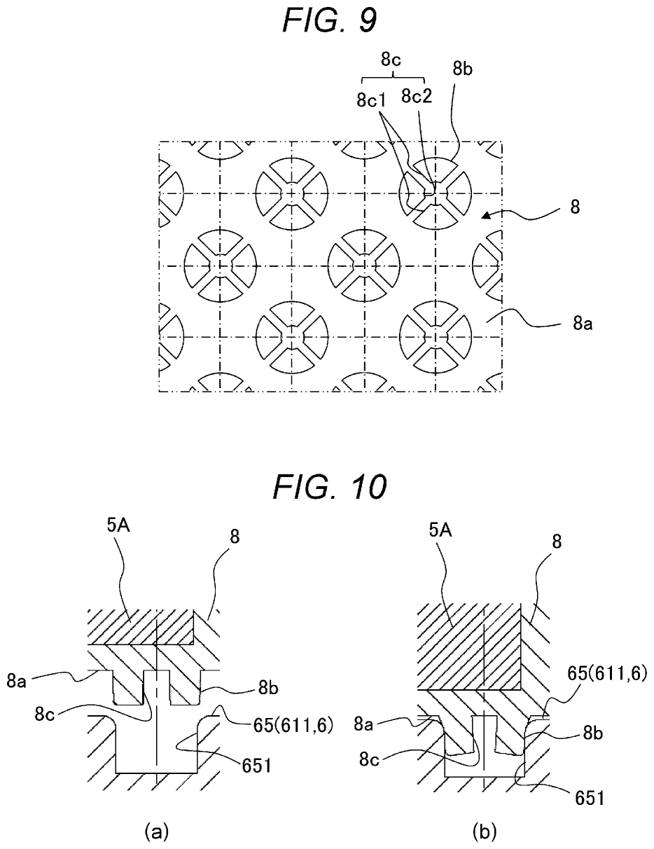

Next, the shape of the block body 8 will be described. FIG. 7 is a perspective view for describing the shape of the block body 8, FIG. 8 is a partially enlarged perspective view of FIG. 7, and FIG. 9 is an enlarged plan view of the end surface 8a of the block body 8.

Referring to FIG. 1, the block body 8 not only covers the surfaces of the plurality of electronic components (noise reduction element 54a and voltage smoothing element 51a), but also is formed in the block shape so as to fill a space between the plurality of electronic components.

Referring to FIGS. 7 and 8, the block body 8 has a plurality of protruding portions 8b protruding from the end surface 8a toward the bottom wall 611 of the inverter accommodation portion 6 (accommodation portion body 61), each of the protruding portions 8b being fitted into a corresponding one of the plurality of recessed portions 651 of the inverter accommodation portion 6 (second installation portion 65) facing such a protruding portion 8b. That is, the plurality of protruding portions 8b and the plurality of recessed portions 651 are formed in sectional shapes which can be fitted to each other in a one-to-one relationship. The number of protruding portions 8b matches the number of recessed portions 651. Here, since the protruding portions 8b are part of the block body 8 made of the thermoplastic resin, the protruding portions 8b also have thermoplasticity. Note that the protruding portion 8b has heat resistance capable of maintaining the state of fitting in the recessed portion 651 within the range of temperature increase due to heat generation of the noise reduction element 54a and the voltage smoothing element 51a.

Although not particularly limited, in the present embodiment, each of the plurality of recessed portions 651 is formed as the straight circular hole as described above, and each of the plurality of protruding portions 8b has a tapered truncated conical outer surface. That is, the hole diameter of each recessed portion 651 is constant in a depth direction, and the inside of each recessed portion 651 is formed as a linearly-extending circular columnar space. Each protruding portion 8b is formed in a slightly-tapered substantially pin-shaped outer shape as a whole, and a taper angle is set to an angle equal to or slightly greater than a draft angle at the time of molding.

Referring to FIG. 9, in the present embodiment, each of the plurality of protruding portions 8b has a deformation allowing groove 8c allowing the protruding portion 8b itself to deform in a direction intersecting a protruding direction. Although not particularly limited, the deformation allowing groove 8c is formed as a groove having, for example, X-shaped grooves 8cl orthogonal to each other and a circular columnar groove 8c2 extending along the center axis of the protruding portion 8b and passing through the intersection of the X-shaped grooves 8c1 in a plan view seen toward the end surface 8a of the block body 8.

FIG. 10 shows views for describing deformation of the protruding portion 8b when the protruding portion 8b is fitted in the recessed portion 651, FIG. 10(a) being a partial sectional view before the deformation and FIG. 10(b) being a partial sectional view after the deformation. Referring to FIG. 10(a), the outer dimension of the protruding portion 8b is set to be slightly greater than the hole diameter of the recessed portion 651. When a tip corner portion of the protruding portion 8b contacts an opening corner portion of the recessed portion 651, the protruding portion 8b is elastically deformed so as to be gradually reduced in diameter from the tip end side in the direction intersecting the protruding direction, specifically in a direction toward the center axis of the protruding direction 8b (in other words, an inward direction toward the recessed portion 651 in the radial direction). Then, as illustrated in FIG. 10(b), the protruding portion 8b is fitted in the recessed portion 651 up to the vicinity of its base end and held in the recessed portion 651. This fitting is made in each protruding portion 8b. As a result, the block body 8 covering the noise reduction element 54a and the voltage smoothing element 51a in the posture of being attached to the circuit board 7 is positioned and held at a predetermined position (second installation portion 65) in the inverter accommodation portion 6 by fitting the plurality of protruding portions 8b in the plurality of recessed portions 651.

In the present embodiment, the target electronic component group 5A is covered with the block body 8 together with a sleeve component 9 through which the board fixing bolts 11 for fixing the circuit board 7 to the inverter accommodation portion 6 penetrate. The sleeve component 9 includes a plurality of sleeve components 9 disposed at a plurality of locations (three locations in the figure) around the target electronic component group 5A on the circuit board 7. The sleeve component 9 is, for example, a cylindrical member made of metal. The sleeve components 9 are integrally molded with the block body 8 at positions close to the circuit board 7-side end surface at an outer edge portion of the block body 8. Referring to FIG. 1, one end of the sleeve component 9 contacts the one surface 7a of the circuit board 7, and the other end of the sleeve component 9 contacts the upper surface of a predetermined one of the plurality of leg portions 641 of the board support portion 64 around the second installation portion 65.

Next, attachment of the circuit board 7 to the board support portion 64 will be described. In the present embodiment, the circuit board 7 is attached to the board support portion 64 after the plurality of power switching elements Q1 to Q6 has been installed (fixed) on the first installation portion 63.

In the present embodiment, among the electronic components forming the inverter 5, the electronic components other than the power switching elements Q1 to Q6 are mounted on the circuit board 7 in advance. Specifically, in the present embodiment, the electronic components forming the target electronic component group 5A (noise reduction element 54a and voltage smoothing element 51a), the diodes D1 to D6, and the control unit 53 are mounted (electrically connected and attached) in advance on the one surface 7a of the circuit board 7 facing the bottom wall 611 of the accommodation portion body 61 (surface facing the partitioning wall W when the circuit board 7 is attached to the board support portion 64). Note that in FIGS. 4 to 6, the diodes D1 to D6 are omitted.

The target electronic component group 5A in the posture of being attached to the one surface 7a of the circuit board 7 is covered with the block body 8 together with the plurality of (three in the figure) sleeve components 9, and is integrated with the circuit board 7.

The circuit board 7 is formed with terminal holes 71 to which the terminals c1 of the power switching elements Q1 to Q6 are connected (inserted). Further, the circuit board 7 is formed with a plurality of insertion holes 72 into which the board fixing bolts 11 can be each inserted. The plurality of insertion holes 72 is formed corresponding to the plurality of leg portions 641 forming the board support portion 64.

The circuit board 7 is placed on the board support portion 64 (i.e., the upper surfaces of the plurality of leg portions 641) of the inverter accommodation portion 6 with the one surface 7a facing down. At this time, each protruding portion 8b of the block body 8 on the end surface 8a thereof is elastically deformed and fitted in a corresponding one of the recessed portions 651 of the inverter accommodation portion 6. In the present embodiment, the height of the noise reduction element 54a from the circuit board 7 is lower than the height of the voltage smoothing element 51a from the circuit board 7. Thus, the height of a portion of the end surface 8a of the block body 8 covering the noise reduction element 54a from the circuit board 7 is lower than the height of a portion of the end surface 8a of the block body 8 covering the voltage smoothing element 51a from the circuit board 7. The height position of the surface of the portion of the second installation portion 65 of the inverter accommodation portion 6 where the recessed portions 651 are formed is different in accordance with a height difference at the end surface 8a of the block body 8. That is, the surface of the portion of the second installation portion 65 where the recessed portion 651 corresponding to the noise reduction element 54a is formed is located closer to the cover member 62 side than the surface of the portion of the second installation portion 65 where the recessed portion 651 corresponding to the voltage smoothing element 51a is formed. That is, in the present embodiment, a step is provided at the second installation portion 65 on which the block body 8 is installed.

The plurality of insertion holes 72 of the circuit board 7 is formed above the bolt holes formed in the upper surfaces of the plurality of leg portions 641, the terminals c1 of the power switching elements Q1 to Q6 are each inserted into the terminal holes 71 of the circuit board 7, and tip end portions thereof protrude from the other surface (surface opposite to the partitioning wall-side surface) of the circuit board 7.

Thereafter, the circuit board 7 placed on the board support portion 64 (the upper surfaces of the plurality of leg portions 641) is fixed to the board support portion 64 with the plurality of board fixing bolts 11. Specifically, the plurality of board fixing bolts 11 inserted into the plurality of insertion holes 72 is screwed into the bolt holes formed in the upper surfaces of the plurality of leg portions 641, and in this manner, the circuit board 7 is fixed to the board support portion 64. At this time, some (three in the figure) of the plurality of board fixing bolts 11 around the block body 8 pass through the sleeve components 9 integrated with the block body 8, and the block body 8 is also fastened to the board support portion 64 with the board fixing bolts 11. In addition, the power switching elements Q1 to Q6 are electrically connected to the circuit board 7 in such a manner that the tip end portions of the terminals cl of the power switching elements Q1 to Q6 are soldered to the circuit board 7. As described above, the circuit board 7 is attached to the board support portion 64. Thereafter, the cover member 62 is attached to the accommodation portion body 61 with a fastening bolt (not illustrated) or the like, whereby the inverter 5 is accommodated in the inverter accommodation portion 6.

In the present embodiment, a gap is provided between the portion (second installation portion 65) of the bottom wall 611 of the inverter accommodation portion 6 facing the end surface 8a of the block body 8 and the end surface 8a of the block body 8. That is, the end surface 8a of the block body 8 does not contact the second installation portion 65 in a state of the protruding portions 8b being elastically deformed and fitted in the recessed portions 651.

In the present embodiment, the circuit board 7 is detachable from the inverter accommodation portion 6 through the plurality of board fixing bolts 11 and the board support portion 64. Note that service holes 73 for bolt loosening are formed in portions of the circuit board 7 corresponding to the element fixing bolts 12. When the circuit board 7 is detached, each element fixing bolt 12 is loosened with a tool inserted through the service hole 73, and in this manner, the power switching elements Q1 to Q6 pressed by the element fixing bolts 12 and the plate 66 are released. As a result, the circuit board 7 is detached together with each electronic element forming the inverter 5 and the block body 8.

The electric compressor 1 according to the present embodiment has the following effects.

The target electronic component group 5A of the noise reduction element 54a and the voltage smoothing element 51a in the posture of being attached to the circuit board 7 of the inverter 5 is covered with the block body 8 made of the thermoplastic resin and formed in the block shape, the circuit board 7 has the one surface 7a which faces the bottom wall 611 located on the housing 4 side in the inverter accommodation portion 6 and to which the target electronic component group 5A is attached, the inverter accommodation portion 6 has the plurality of recessed portions 651 formed in the portion of the bottom wall 611 facing the end surface 8a of the block body 8, and the block body 8 has the plurality of protruding portions 8b protruding from the end surface 8a thereof toward the bottom wall 611, each of the plurality of protruding portions 8b being fitted in a corresponding one of the plurality of recessed portions 651 facing such a protruding portion 8b. Thus, heat generated from the target electronic component group 5A (noise reduction element 54a and voltage smoothing element 51a) is efficiently dissipated from the plurality of protruding portions 8b of the block body 8 itself to the housing 4 side with a wide heat transfer area through the inner walls of the plurality of recessed portions 651 without separately providing a heat dissipation sheet member. As described above, the electric compressor 1 can reduce the number of components as compared with the related art while ensuring the heat dissipation (cooling performance) of the noise reduction element and the voltage smoothing element, and consequently, a manufacturing cost can be reduced.

Since the block body 8 is made of the thermoplastic resin, even if the manufacturing tolerances of the dimensions of the protruding portion 8b and the recessed portion 651 are great, the protruding portion 8b is elastically deformed, and accordingly, fitting between the protruding portion 8b and the recessed portion 651 is made. Consequently, assembling workability is also improved. Even in a case where the step is provided at the second installation portion 65 on which the block body 8 is installed as in the present embodiment, the protruding portion 8b is elastically deformed, and therefore, the block body 8 is stably installed without using a shim or a thin sheet material for fine adjustment of the height of the installation surface. In addition, due to the elasticity of the thermoplastic resin, generation of repulsive force to the electronic component at the time of fitting is also reduced, and the load on the electronic component is reduced.

In the present embodiment, each of the plurality of protruding portions 8b has the deformation allowing groove 8c allowing the protruding portion itself to deform in the direction intersecting the protruding direction. With this configuration, the protruding portion 8b is more easily elastically deformed, and therefore, the block body 8 can be easily positioned at the time of assembly, and the assembling workability can be further improved.

In the present embodiment, the target electronic component group 5A is covered with the block body 8 together with a sleeve component 9 through which the board fixing bolts 11 for fixing the circuit board 7 to the inverter accommodation portion 6 penetrate. With this configuration, the vibration resistance of the target electronic component group 5A is improved.

In the present embodiment, the electronic components forming the switching unit 52 and the control unit 53 are attached to the circuit board 7 together with the target electronic component group 5A, and the circuit board 7 is detachable from the inverter accommodation portion 6. With this configuration, the number of components of the inverter 5 is reduced, the size is reduced, and the assemblability is improved.

In the present embodiment, the gap is provided between the portion of the bottom wall 611 of the inverter accommodation portion 6 facing the end surface 8a of the block body 8 and the end surface 8a of the block body 8. With this configuration, the amount of resin used for the block body 8 itself is reduced.

Note that the end surface 8a of the block body 8 may contact the bottom wall 611. The shape of the deformation allowing grooves 8c of the protruding portion 8b is not limited to the X-shape, and may be an I-shape or the like. Further, the deformation allowing grooves 8c may not be provided. As long as the protruding portion 8b can be fitted in the recessed portion 651, the shapes and the numbers of the protruding portions 8b and the recessed portions 651 can be arbitrarily set.

As described above, the embodiment of the present invention and its modifications have been described above. However, the present invention is not limited to the foregoing embodiment and modifications, and as a matter of course, the present invention can be further modified based on the technical idea of the present invention.

### LIST OF REFERENCE SIGNS

1 Electric Compressor
2 Electric Motor
3 Compression Mechanism
4 Housing
5 Inverter
5A Target Electronic Component Group
51a Voltage Smoothing Element
54a Noise Reduction Element
6 Inverter Accommodation Portion
7 Circuit Board
7a One Surface
8 Block Body
8a End Surface
8b Plurality of Protruding Portions
8c Deformation Allowing Groove
9 Sleeve Component
11 Board Fixing Bolt
52 Switching Unit
53 Control Unit
611 Bottom Wall
651 Plurality of Recessed Portion
Q1 to Q6 Power Switching Element

1. An electric compressor comprising:
an electric motor;
a compression mechanism driven by the electric motor to compress refrigerant;
an inverter including a target electronic component group of a noise reduction element and a voltage smoothing element and driving the electric motor;
a housing accommodating the compression mechanism and the electric motor;
an inverter accommodation portion provided adjacent to the housing and accommodating the inverter; and
a block body covering the target electronic component group in a posture of being attached to a circuit board of the inverter, formed in a block shape, and made of resin,
wherein the circuit board has one surface which faces a bottom wall located on a housing side in the inverter accommodation portion and to which the target electronic component group is attached,
the resin is thermoplastic resin,
the inverter accommodation portion has a plurality of recessed portions formed in a portion of the bottom wall facing an end surface of the block body, and
the block body has a plurality of protruding portions protruding from the end surface toward the bottom wall, each of the protruding portions being fitted in a corresponding one of the plurality of recessed portions facing each of the protruding portions.

2. The electric compressor according to claim 1, wherein each of the plurality of protruding portions has a deformation allowing groove allowing each of the plurality of protruding portions itself to deform in a direction intersecting a protruding direction.

3. The electric compressor according to claim 1, wherein the target electronic component group is covered with the block body together with a sleeve component through which a board fixing bolt for fixing the circuit board to the inverter accommodation portion penetrates.

4. The electric compressor according to claim 1, wherein
the inverter includes a switching unit having a plurality of power switching elements and a control unit that controls the plurality of power switching elements based on an external signal,
an electronic component forming the switching unit and the control unit is attached to the circuit board together with the target electronic component group, and
the circuit board is detachable from the inverter accommodation portion.

5. The electric compressor according to claim 1, wherein a gap is provided between a portion of the bottom wall of the inverter accommodation portion facing the end surface of the block body and the end surface of the block body.

6. The electric compressor according to claim 2, wherein a gap is provided between a portion of the bottom wall of the inverter accommodation portion facing the end surface of the block body and the end surface of the block body.

7. The electric compressor according to claim 3, wherein a gap is provided between a portion of the bottom wall of the inverter accommodation portion facing the end surface of the block body and the end surface of the block body.

8. The electric compressor according to claim 4, wherein a gap is provided between a portion of the bottom wall of the inverter accommodation portion facing the end surface of the block body and the end surface of the block body.
